(19) United States
(12) Patent Application Publication
(10) Pub. No.: US 2009/0173290 A1
(43) Pub. Date: Jul. 9, 2009

(54) PROTECTIVE CLOTHING FOR ANIMALS

(76) Inventor: Norbert Freitag, Hochst (AT)

Correspondence Address: VOLPE AND KOENIG, P.C., UNITED PLAZA, SUITE 1600, 30 SOUTH 17TH STREET, PHILADELPHIA, PA, 19103, US

(21) Appl. No.: 12/362,911

(22) Filed: Jan. 30, 2009

Related U.S. Application Data
(63) Continuation of application No. PCT/EP2007/000368, filed on Jul. 26, 2007.

(30) Foreign Application Priority Data
Aug. 4, 2006 (AT) 590/2006

(51) Int. Cl. A01K 13/00

(52) U.S. Cl. 119/850; 54/79.2

(57) ABSTRACT

Protective clothing for animals is formed from an elastic woven, meshed, or knitted fabric, and individual sections (2) or border regions (3, 4) of these sections are connected rigidly, but detachably to each other. The bordering sections (2) or border regions (3, 4) of the woven, meshed, or knitted fabric are arranged overlapping each other and are connected to each other by two-part snap-fastener elements (1). The bordering and overlapping sections (2) or border regions (3, 4) lying in the region of the snap-fastener element (1) take on a shape in a non-destructive manner between the two parts (5, 6) of the snap-fastener elements (1), wherein this shape is determined by the parts (5, 6) of the snap-fastener element (1) that can be inserted one inside the other.

### CROSS-REFERENCE TO RELATED APPLICATIONS

This application is a continuation of PCT/EP2007/000368, filed Jul. 26, 2007, which claims the benefit of Austrian Application GM 590/2006, filed Aug. 4, 2006, both of which are incorporated herein by reference as if fully set forth.

### BACKGROUND

The invention relates to protective clothing for animals made from an elastic woven textile, mesh, or knitted fabric, wherein individual sections or border regions of this fabric are connected to each other rigidly, but detachably.

Protective clothing of various configurations have become known, wherein individual sections are connected to each other by hook and loop fasteners (US2004/0031448 A1 or U.S. Pat. No. 6,234,117 B1), straps (U.S. Pat. No. 6,880,489 B2 or DE20311220 U1) or rivets penetrating the protective clothing (U.S. Pat. No. 3,141,443 A). Here, prior fabrication of different sizes and blanks is always required. Individual adaptation is usually not possible.

### SUMMARY

The present invention therefore has the objective of providing a special type of connection between individual sections of protective clothing or border regions of this clothing with which optimal adaptation to various body shapes and sizes of the animal bodies is possible, without producing a negative effect on the skin or coat of an animal.

This is possible according to the invention in that sections or border regions of the sections of the woven, meshed, or knitted fabric bordering each other are arranged overlapping each other and are connected to each other by two-part snap-fastener elements, wherein the bordering or overlapping sections or border regions lying in the region of the snap-fastener elements take on a shape in a non-destructive manner between the two parts of the snap-fastener elements, wherein this shape is determined by the parts of the snap-fastener elements that can be inserted one in the other.

Therefore, the connection of sections or border regions of these sections bounding each other can be realized at any position, that is, at the most accessible positions. Also absolutely no damage to the sections is produced, because the sections or border regions to be connected to each other take on a shape together and in a non-destructive manner, wherein this shape is determined by the parts of the snap-fastener element that can be inserted one in the other. After removal of the snap-fastener element, the sections or their border regions return to the original, flat starting position.

Snap fasteners are typically sewn or attached in some other way to the insides of the sections or border regions of these sections to be connected to each other and therefore come into direct, active connection with each other. In contrast, for the construction according to the present invention, the two parts of the snap-fastener element are introduced from the outer surfaces of the sections or the border regions of these sections and guided one into the other with the sections in-between. Therefore, the parts of the snap-fastener element can also be attached without the otherwise typical attachment to the sections. In this way, the elasticity of the section or the border region of this section is possibly inhibited in the immediate region of the snap-fastener elements, however, the woven, meshed, or knitted fabric is never cut or damaged in some other way. The connection of these snap-fastener elements is here so good that the animals cannot undue these connections themselves.

Furthermore, it is proposed that the sections or border regions of the woven, meshed, or knitted fabric bounding each other are cut adapted to each other, in order to guarantee sufficient overlap and thus placement of the snap-fastener elements. An individual cut is therefore always possible, according to whether all of the body parts of the animal or only individual limbs are to be covered.

One special configuration for the clothing of the animal body itself is given according to the invention when a basic section encompassing an animal body is held together at two border regions allocated to each other by snap-fastener elements.

In one use of protective clothing for certain types and sizes of animals, a certain prior fabrication is also possible, in that slits or holes are cut out or stamped from the basic section for leading through the legs, the tail, the penis, etc. If necessary, prior fabrication can be realized, wherein, however, additional adaptation through cutting can still be realized.

One advantageous configuration provides that stocking-like sections for the legs and/or the tail of an animal can be placed on the holes, wherein these sections are attached to the border region of the basic body bounding the holes by snap-fastener elements. In the same way, additional sections can also be connected to a basic section.

In connection with this, one variant provides that the stocking-like sections are produced from flat parts that are connected to each other by snap-fastener elements at their opposing border regions. These sections therefore can also be produced as flat elements, because they then form a stocking-like section by use of the snap-fastener elements after encircling the corresponding limbs.

In another embodiment it is provided that the stocking-like sections are produced as such in one piece that are attached by snap-fastener elements at the border region of the basic body bounding the holes. Then only an attachment with the border regions of the holes is still necessary, wherein there the snap-fastener elements are also used.

In connection with this, it is advantageous when the stocking-like sections are significantly longer than is typically necessary, wherein for use a length required for a certain animal is cut away. Here it is also possible to leave the stocking-like sections longer and, e.g., to button up or turn over the projecting area in the foot region of the animal, so that the foot region can also be covered with the protective clothing.

Another configuration is given when the stocking-like sections have a conical, tubular construction, that is, have different diameters at their two ends. This is especially advantageous for limbs with very different dimensions. Here it is also possible that a special intermediate section is cut out that is then fitted just for this particular animal.

In the scope of the invention, however, it is also possible that the stocking-like sections have a cylindrical, tubular construction. Through the elasticity of the woven, meshed, or knitted fabric that is used, large differences in diameter in the limbs of an animal can be bridged accordingly.

An especially advantageous effect is realized when all of the sections are formed from a woven, meshed, or knitted fabric that is elastic in all directions. Thus, good adaptation to all surfaces of an animal is always guaranteed. In particular, no pressure points are produced. Even raised sections produced when wound bandages are applied are covered in this way without a problem, so that soft pressure is also exerted, so that the bandaging cannot slip. In addition, in the way according to the invention, wound bandages, wound coverings, or the like can be connected to the elastic, woven, meshed, or knitted fabric and thus can be held securely without slipping.

An especially advantageous configuration of the protective clothing is then given when all of the sections or individual sections are formed from a run-free, woven, meshed, or knitted fabric that is elastic in all directions. In this way it is possible that the border region of a section is cut at any position or that a hole is cut out from the full section at the desired position. The setup of the elastic, woven, meshed, or knitted fabric is thus jointly decisive for an optimum configuration of the protective clothing according to the invention.

Furthermore, it is provided that the snap-fastener elements are produced from plastic. Although metal constructions are also conceivable, the construction made from plastic has proven to be very friendly to the skin of the animals. Here, it is advantageous when the snap-fastener elements are produced from an elastic plastic. Thus, the immediate region of the connection is also elastic accordingly, so that stress on the surface of the body of the animal can be prevented.

Another configuration provides that the snap-fastener elements are coated on their plate-like inner surfaces with an adhesive or carry a self-adhesive film. Therefore, the parts of the snap-fastener elements can remain in their position, for example, after the first connection. This is then useful, optionally, when multiple detachment and attachment is necessary, for example, when a wound treatment is to be repeated continuously. Here it is conceivable that the snap-fastener elements carry a double-sided, self-adhesive film on their plate-like inner surfaces. The snap-fastener elements can be prepared for multiple uses immediately before the first use. Here, it is also possible to provide a film covering the adhesive position, wherein this film then can be removed before the first use—if a fixed adhesion is desired.

### BRIEF DESCRIPTION OF THE DRAWINGS

Furthermore, features according to the invention and special advantages will be explained in greater detail in the following description with reference to the drawings.

Shown in the drawing are:

FIG. 1 is a side view of a dog with protective clothing covering the body,

FIG. 2 is a diagram of the connection of the border region of a section of the protective clothing shortly before the compression of the two parts of the snap-fastener element,

FIG. 3 is a view of a dog from behind with a connection of the border regions realized on the rear side,

FIG. 4 is a view, shown schematically, of the connection of two border regions of a section,

FIG. 5 is a view of a dog from behind with the diagram of several possible connections of the protective clothing,

FIG. 6 is a side view of a dog with protective clothing,

FIG. 7 is a top view of the dog,

FIG. 8 is a view of the dog from below,

FIG. 9 is a side view of a dog with protective clothing for a leg,

FIG. 10 is a schematic diagram of a stocking-like section that can be used for protective clothing of a leg for large animals, e.g., horses,

FIG. 11 is a view showing the use of a section according to FIG. 10 for a horse,

FIG. 12 is a view showing the construction of a basic section as a sweat blanket for horses,

FIG. 13 is a view showing the construction of a stocking-like section for the calf region of a horse.

### DETAILED DESCRIPTION OF THE PREFERRED EMBODIMENTS

The protective clothing according to the invention for animals should be able to create, in particular, protection after operations or for other required covering of body parts. This protective clothing can actually be used for all types and sizes of animals, wherein naturally attention must be given to the anatomical conditions. In the following description, reference is made to dogs. In the same way, such protective clothing can also be used for cats or for even smaller animals, such as rats, mice, rabbits, guinea pigs, ferrets, birds, fish, or the like, but also for larger animals up to horses or the like.

This protective clothing for animals is made from an elastic woven textile, meshed, or knitted fabric, wherein individual sections or border regions of these sections are connected to each other rigidly, but detachably. In the configuration according to the invention, bordering sections 2 or border regions 3, 4 of the woven, meshed, or knitted fabric are arranged overlapping each other and connected to each other by two-part snap-fastener elements 1. If possible, care must be taken that the finer ribbing is arranged on the outside of the sections and the wider ribbing is arranged on the body side, so that moisture can be better suctioned on the body side and a better dissipation of the moisture to air is possible on the outside. The bordering and overlapping sections 2 or border regions 3, 4 lying in the region of the snap-fastener element 1 take on a shape in a non-destructive manner between the two parts 5, 6 of the snap-fastener elements 1, wherein this shape is here determined by the parts 5, 6 of the snap-fastener element 1 that can be inserted one into the other. Here, in the closed state of each snap-fastener element 1, a projection (plunger) of one part 5 extends through an opening in the other part 6, wherein the sections 2 or border regions 3, 4 of these sections 2 to be connected run over this projection of one part 5 and are thus pressed by this projection through the opening in the other part 6.

The projection of one part 5 is locked in the opening of the other part 6—under intermediate connection of the positions of the woven, meshed, or knitted fabric. For example, the projection of one part 5 can be constructed in this way, as shown, with a mushroom-head shape.

The sections 2 or border regions 3, 4 of the woven, meshed, or knitted fabric bordering each other are cut matched to each other, in order to guarantee sufficient overlap and thus the placement of the snap-fastener elements 1. Individual sections, however, can also have a one-piece tubular or stocking-like construction, as still to be explained in greater detail. The connection using the snap-fastener elements can be realized either as shown in the stomach region of the animal body 7 or else on the back region or also on one or on both side regions of the animal body 7.

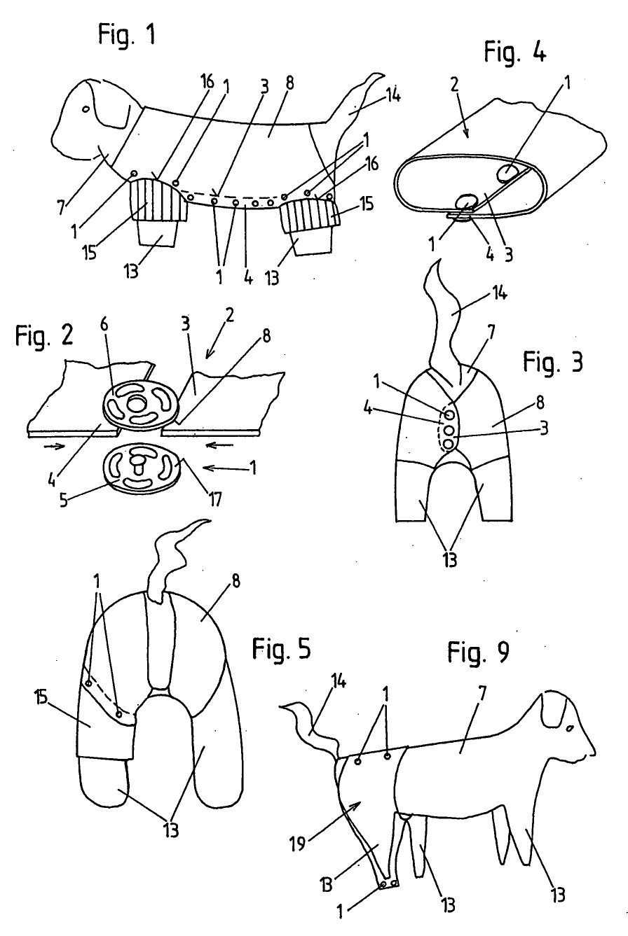

According to FIGS. 1 and 6 to 7, the protective clothing is formed by a basic section 8 that encircles the animal body 7 and that is held together at two border regions 3, 4 allocated to each other by snap-fastener elements 1. From the basic section 8, slots 9 or holes 10 to 12 are cut or punched for guiding through the leg 13, the tail 14, the penis, etc.

As can be taken from FIGS. 1 and 5, stocking-like sections 15 for the leg 13 and/or the tail 14 of an animal can be set in the holes 10, 11. These stocking-like sections 15 are attached to the border region 16 of the basic body 8 bordering the holes 10, 11 by snap-fastener elements 1. In the actual example, the basic body 8 is formed from a flat section that is connected at its border regions 3, 4 by the snap-fastener elements 1 to a stocking-like or hose-like section. Then, stocking-like or hose-like sections 15 that are connected, in turn, by the snap-fastener elements 1 then attach to the holes 10, 11. Such a configuration can be used successfully, in particular, also for preventing pregnancies in animals. The sections 15 form a sort of shorts on the basic section 8.

The stocking-like sections 15 can be made from flat parts that are connected to each other at their opposing border regions by snap-fastener elements 1. The stocking-like or hose-like sections 15 are produced only after the connection by the snap-fastener elements.

It is also possible, however, to produce the stocking-like sections 15 as such in one piece and then to attach these sections 15 to the border region of the basic body 8 bordering the holes 10, 11 by use of snap-fastener elements 1. In an especially advantageous way, the stocking-like sections 15 are significantly longer than typically necessary, wherein for use a length required for a certain animal is then cut.

Another embodiment provides for construction of the stocking-like sections 15 in a conical shape, so that these have different diameters at their two ends. However, it is also conceivable to form the stocking-like sections 15 with a cylindrical, tubular form.

It is especially essential for an effective use of the protective clothing that all of the sections 2, 15, etc. are formed from a woven, meshed, or knitted fabric that is elastic in all directions. Here, it is of special significance, in particular, when slots or holes are cut at arbitrary desired regions of a section, when all or individual sections 1, 15 are formed from a run-free, woven, meshed, or knitted fabric that is elastic in all directions. Also, if holes are cut by hand at a later time, this leads to significant damage to the sections, because no runs reduce the stability of the woven, meshed, or knitted fabric. Even through the special type of woven, meshed, or knitted fabric, a secure holding together with contact pressure for binding material, but also optimal fixing of probes of EKG devices to be used is achieved. Here, the connection between the binding material or probes with the elastic woven, meshed, or knitted fabric can also be realized by the use of the snap-fastener elements.

The snap-fastener elements 1 are produced advantageously from plastic. Therefore, corrosion is not generated due to the body sweat or additional, hard positions cannot be easily produced in the protective clothing. In connection with this, it is useful when the snap-fastener elements 1 are produced from an elastic plastic. Because a double layer of border regions 3, 4 of a section 2 must be formed and fixed between the two parts 5, 6 of the snap-fastener elements and this connection also must withstand corresponding stress, the use of plastic with corresponding elasticity has proven more advantageous than the use of metals. Therefore, tolerances in the region of the two parts 5, 6 of the snap-fastener elements 1 can be compensated much better.

If the snap-fastener elements 1 are to be detached multiple times and re-used at the same position, the parts 5 and 6 can also be connected to the surface of the relevant section 2, 8 of the protective clothing. For this purpose it can be provided that the snap-fastener elements 1 are coated on their plate-like inner surfaces 17 and 18 with an adhesive or carry a self-adhesive film. For the use of a self-adhesive film, a double-sided, self-adhesive film can also be used that optionally has a protective film that covers the adhesive surface and that can then be removed when needed. In connection with this, it is also conceivable to apply an adhesive drop set under pressure in the region of one or both parts 5, 6 of the snap-fastener element 1, so that one or both parts 5, 6 can be adhered on a corresponding surface. Positions suitable for adhesive are here provided on horn-like skin, horns, hoofs, etc.

In the diagram according to FIG. 3 it can be seen on the rear side of the animal body, a basic section 8 can be connected rigidly, but detachably to overlapping regions 3, 4 by snap-fastener elements 1.

FIG. 4 shows schematically that from a flat section 2 and with corresponding overlapping a connection can be created by a corresponding number of snap-fastener elements 1 to form a stocking-like or hose-like section.

In the scope of the invention, naturally other flat sections or stocking-like sections can also be used, for example, as ear protection, vein protection, or muzzle.

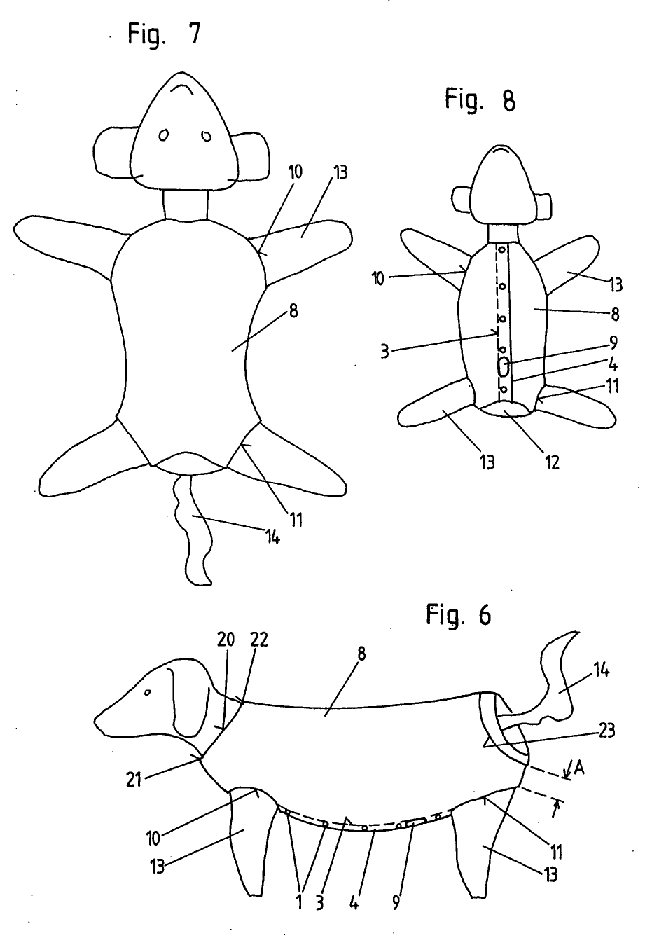

In the configuration according to FIGS. 6 to 8, it can be provided to form a closed, hose-like basic section 8 in one piece. However, it is also conceivable to form this basic section 8 as a surface element and to connect it at the two facing border regions 3, 4 by the use of the snap-fastener element 1 for forming a hose-like shape. Here, the joint for mutual, overlapping arrangement is naturally also provided on the bottom side, on the top side, or on the side regions of the animal body 7. If seams should be required at certain positions, these are advantageously constructed as flat stretch seams.

In order to allow good adaptation of the protective clothing to the anatomical conditions of the dog, the front closure 20 of the basic section 8 can be cut into a point, so that the bottom-lying section 21 projects farther than the upper-lying section 22.

In this connection, however, it is also possible to extend the hose-like basic section 8 at its upper, front closure in the top view essentially in a triangular shape, in order to somewhat cover the back of the neck of the dog with the flaps formed in this way.

The hose-like basic section 8 can be extended in side view in an essentially triangular shape at its lateral, rear closure regions 23. Therefore it can also be prevented that the distance A between the holes 11 and the rear closure regions becomes too small. Therefore it is also prevented that this region becomes too narrow behind the legs 13 and therefore possibly cuts in like a cord.

An especially effective measure lies in that the holes 10, 11 are constructed with an essentially elliptical shape for the passage of the feet 13 of the animal. Here, a special embodiment lies in that the holes 10, 11 are constructed with an essentially elliptical shape for the passage of the feet 13 of the animal, wherein, however, the sections of the holes 10, 11 coming in contact with the inside of the feet 13 have a straight-lined profile.

In adaptation to the anatomical conditions, it can still be provided that the holes 10 have a smaller distance from each other for passing the front feet of the animal than the holes 11 for passing through the back feet of the animal.

Another structural configuration provides, on the bottom side of the basic section 8, an additional oval or lens-shaped slot 9 for passing through the penis of male animals. Here, a slot 9 can also be prepared for passing through the member of male animals as a buttonhole that can be cut when needed for forming a real slot 9.

Even for the use for female dogs, a variant is useful in which the rear end region of the basic section 8 can be closed at least partially by extended flaps.

For the configuration according to FIG. 9 it is shown that protective clothing can also be used for a certain member of an animal. Here, a stocking-like section 19 is used that encircles a foot 13 of the dog. At the free end of this section 19, this is closed, for example, by an attached button or else by the use of snap-fastener elements 1. Here, on the opposite foot a type of hose-like section can be placed, wherein then these two sections can be connected to each other at the height of the back of the animal 7, in turn, by snap-fastener elements 1.

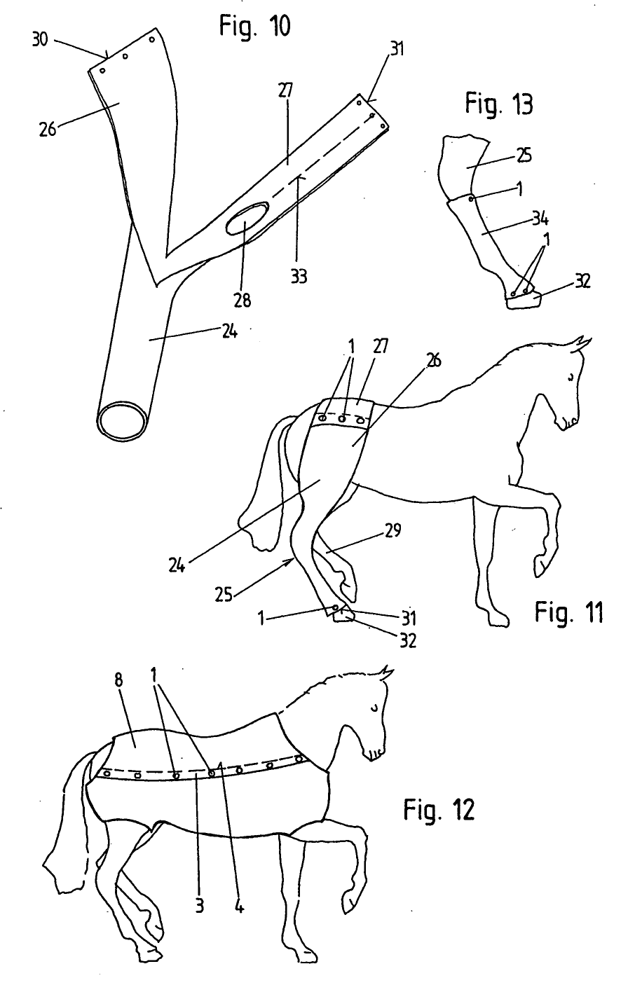

In the configuration according to FIGS. 10 and 11, a stocking-like section 24 can be used as legging for large animals, e.g., for horses. Naturally, such a section can also be used for smaller animals, e.g., for dogs or cats. This stocking-like section 24 is left in the tubular shape at the length needed for covering a foot 25 of the horse. The other region is cut into two regions 26 and 27 centrally or approximately centrally, so that two regions 26 and 27 separated from each other are produced. In one region, a hole 28 is then cut through which the opposite foot 29 of the horse can be threaded. The two ends 30 and 31 of the regions 26 and 27 are connected to each other overlapping each other at a side region of the horse by snap-fastener elements 1. The lower end 31 of the section 24 is connected by snap-fastener elements 1 whose one part is adhered to the hoof 32, on the foot 25 of the horse. The region 27 can also be cut along the line 33, wherein the two halves formed in this way are guided past on opposite sides of the foot 29, wherein then the ends 31 and 32 are connected again to each other overlapping. Here it is definitely possible that the region 27 is constructed longer than the region 26. Overall, the stocking-like section 24 must have a corresponding total length, wherein then one or the other region 26 or 27 is cut to the required length.

As can be seen from FIG. 12, the arrangement according to the invention can also be used as sweat covering for horses with a basic section 8 connected to the border regions 3, 4 by the use of the snap-fastener element 1, without this covering being able to slip.

Another structural configuration is to be taken from FIG. 13. Here, a type of stocking-like section 34 is attached to the calf region of the foot 25 of a horse. The lower end of this section 34 can be attached to the hoof 32 by an adhered snap-fastener element 1. The lower end of this section can also be attached by a snap-fastener element 1 and indeed at a horn-like projection on the foot 25 of the horse. Here, this section 34 is also held non-detachably and thus can be used for covering a wound or a bandage placed over a wound.

In the scope of the invention, the protective clothing can also be used for other purposes. Not only the color configuration of the protective element can be changed variably and thus can also be adapted to fashionable main features, definitely different designs can also be conceivable. There are also other possibilities, in that, namely the sections 2, 8, and/or 15 is printed over the entire surface or on part of the surface with advertisements or logos. One possibility can also be provided to attach written instructions on the type of injury, etc.

The protective clothing according to the invention is suitable, in a special measure, for good healing of operation or other wounds for animals of all types or also for the required covering for rashes, etc.

### LEGEND TO THE REFERENCE NUMBERS

1 Snap-fastener element
2 Section
3 Border region
4 Border region
5 Part of the snap-fastener element
6 Part of the snap-fastener element
7 Animal body
8 Basic section
9 Slot
10 Hole
11 Hole
12 Hole
13 Leg
14 Tail
15 Stocking-like section
16 Border region
17 Inner surface
18 Inner surface
19 Stocking-like section
20 Closure
21 Section lying at the bottom
22 Section lying at the top
23 Rear closure region
24 Section
25 Foot
26 Region
27 Region
28 Hole
29 Foot
30 End
31 End
32 Hoof
33 Line
34 Section

1. Protective clothing for animals made from elastic woven, meshed, or knitted fabric, comprising individual sections of the woven, meshed, or knitted fabric that are connected to each other rigidly but detachably, the individual sections (2, 8, 15) or border regions (3, 4) of the sections are arranged overlapping each other and connected to each other by two-part snap-fastener elements (1), the sections (2, 8, 15) or border regions (3, 4) of the sections lying in a region of the snap-fastener element (1) take on a shape in a non-destructive manner between the two parts (5, 6) of the snap-fastener element (1), wherein the shape is determined by the parts (5, 6) of the snap-fastener element (1) that can be inserted one in the other.

2. Protective clothing according to claim 1, wherein the sections (2, 8, 15) or border regions (3, 4) of sections are cut adapted to each other, in order to guarantee a sufficient overlap and thus a placement position of the snap-fastener elements (1).

3. Protective clothing according to claim 1, wherein one of the sections comprises a basic section (8) for encircling an animal body (7) that is held together at two of the border regions (3, 4) allocated to each other by the snap-fastener elements (1).

4. Protective clothing according to claim 3, wherein slots (9) or holes (10, 11) are cut or punched in the basic section (8) that are adapted for guiding through a leg (13), a tail (14), a penis, or other body parts of the animal.

5. Protective clothing according to claim 4, wherein stocking-like ones of the sections (15) for the leg (13) or the tail (14) of an animal (7) are placed at the holes (10, 11), wherein the stocking-like sections are attached to the border region of the basic body (8) bordering the holes (10, 11) by the snap-fastener elements (1).

6. Protective clothing according to claim 5, wherein the stocking-like sections (15) are made from flat parts that are connected to each other at opposite border regions by the snap-fastener elements (1).

7. Protective clothing according to claim 5, wherein the stocking-like sections (15) are produced as such in one piece, and are attached to the border region of the basic body (8) bordering the holes (10, 11) by the snap-fastener elements (1).

8. Protective clothing according to claim 5, wherein the stocking-like sections (15) have a conically tubular construction, with different diameters at two ends thereof.

9. Protective clothing according to claim 5, wherein the stocking-like sections (15) have a cylindrical, tubular construction.

10. Protective clothing according to claim 1, wherein all of the sections (2, 8, 15) are formed from woven, meshed, or knitted fabric that is elastic in all directions.

11. Protective clothing according to claim 1, wherein all of the sections or individual sections (2, 8, 15) are formed from a run-free, woven, meshed, or knitted fabric that is elastic in all directions.

12. Protective clothing according to claim 1, wherein the snap-fastener elements (1) are comprised of plastic.

13. Protective clothing according to claim 12, wherein the snap-fastener elements (1) are made from an elastic plastic.

14. Protective clothing according to claim 1, wherein the snap-fastener elements (1) includes plate-shaped inner surfaces and are coated with an adhesive or carry a self-adhesive film on the plate-shaped inner surfaces (17, 18).

15. Protective clothing according to claim 14, wherein the snap-fastener elements (1) carry a double-sided, self-adhesive film on the plate-shaped inner surfaces (17, 18).
